(19) United States
(12) Patent Application Publication
(10) Pub. No.: US 2013/0303355 A1
(43) Pub. Date: Nov. 14, 2013

(54) REAGENT VESSEL INSERT AND REAGENT VESSEL

(71) Applicant: Robert Bosch GmbH, Stuttgart (DE)

(72) Inventors: Martina Daub, Weissach (DE); Guenter Roth, Freiburg (DE); Juergen Steigert, Stuttgart (DE); Nils Paust, Freiburg (DE)

(21) Appl. No.: 13/855,908

(22) Filed: Apr. 3, 2013

(30) Foreign Application Priority Data
Apr. 4, 2012 (DE) 10 2012 205 523.1

(51) Int. Cl. B04B 11/00

(52) U.S. Cl. CPC B04B 11/00
USPC 494/37; 422/548; 422/565

(57) ABSTRACT

A reagent vessel insert includes an insert housing formed in such a way that the reagent vessel insert is configured to be inserted in a reagent vessel for a centrifuge and/or for a pressure varying device. The reagent vessel insert further includes at least one magnet arranged non-adjustably with respect to the insert housing and at least one adjusting element arranged in an interior volume of the reagent vessel insert. The at least one adjusting element is at least partially formed from a magnetically attractable material such that a magnetic force of attraction exerted by the at least one magnet on the at least one adjusting element is at least greater than a force of the weight of the at least one adjusting element. A method includes one or more of centrifuging and pressure treating a material using the reagent vessel insert or a reagent vessel.

This application claims priority under 35 U.S.C. §119 to patent application no. DE 10 2012 205 523.1, filed on Apr. 4, 2012 in Germany, the disclosure of which is incorporated herein by reference in its entirety.

### BACKGROUND

The disclosure relates to a reagent vessel insert. The disclosure similarly relates to a reagent vessel. The disclosure also relates to a method for the centrifuging of a material and to a method for the pressure treatment of a material.

DE 10 2010 003 223 A1 describes a device for inserting into a rotor of a centrifuge. The device, taking the form of a standard centrifuge tube, may comprise various turrets, which are arranged axially one on top of the other. The turrets may have channels, cavities, reaction chambers and further structures for carrying out fluidic unit operations. The turrets can be rotated with respect to their positions in relation to one another by means of an integrated ballpoint pen mechanism, whereby the structures of the turrets can be switched in relation to one another. An updating of the ballpoint pen mechanism can be initiated after the insertion of the device into a centrifuge by means of the centrifugal force brought about by the operation of the centrifuge. At the same time, liquids can be transferred along the force vector of the centrifugal force that is brought about.

### SUMMARY

The disclosure relates to a reagent vessel insert, a reagent vessel, a method for the centrifuging of a material, and a method for the pressure treatment of a material.

The present disclosure realizes magnetic systems as a counterpart to a centrifugal force brought about by means of a centrifuge and/or a compressive force brought about by means of a pressure varying device, which can be integrated in chemical processes and/or biochemical processes. For example, the magnetic systems may be used for controlling with greater precision a liquid flow in the course of the chemical and/or biochemical processes, in particular counter to the centrifugal force and/or the compressive force. While the liquid flow can conventionally be controlled only by the centrifugal force brought about by means of the centrifuging or by the compressive force brought about by means of the pressure varying device, the liquid flow can be controlled even more accurately by means of the present disclosure.

In an advantageous embodiment, the at least one adjusting element is adjustable with respect to the at least one magnet by means of a centrifugal force that can be brought about when operating the centrifuge in the rotor device of which the reagent vessel with the reagent vessel insert inserted therein is arranged and is greater than the magnetic force of attraction and/or by means of a compressive force that can be brought about when operating the pressure varying device in which the reagent vessel with the reagent vessel insert inserted therein is arranged and is greater than the magnetic force of attraction. A current position of the at least one adjusting element can thus be freely set by means of the centrifugal force and/or the compressive force.

For example, by means of the at least one adjusting element adjusted with respect to the at least one magnet, a cutting edge, a point and/or a spike can be brought into contact with a layer that can be penetrated by means of the cutting edge, the point and/or the spike. The magnetic system in this case performs the function of a cutting-open mechanism and/or a severing mechanism.

As an alternative or addition to this, the at least one adjusting element may be adjustable with respect to the at least one magnet from at least one starting position into at least one operating position, there being between the at least one adjusting element in its at least one starting position and a surrounding of the adjusting element in its at least one starting position a first through-flow area that is unequal to a second through-flow area between the at least one adjusting element in its at least one operating position and a surrounding of the adjusting element in its at least one operating position. The magnetic system consequently can be used as a throttle.

In particular, the at least one adjusting element in its at least one starting position and/or in its at least one operating position may close with a liquidtight seal a channel-restricting region that is formed in the interior volume. This allows the magnetic system also to be used as a valve.

In an advantageous development, the reagent vessel insert comprises at least one turret and/or a ballpoint pen mechanism. The technology of the advantageous reagent vessel insert can consequently be combined with other technologies for controlling chemical and biochemical processes.

The at least one magnetic system formed by the at least one magnet and the at least one adjusting element may be designed as a cutting-open mechanism, a severing mechanism, a throttle, a valve, a closing device, a flap mechanism, a pump and/or a mixing device. It is pointed out that the magnetic system represents a low-cost way of implementing the functions enumerated here that requires little installation space.

The aforementioned advantages can also be brought about by means of the corresponding reagent vessel, the method for the centrifuging of a material and the method for the pressure treatment of a material.

### BRIEF DESCRIPTION OF THE DRAWINGS

Further features and advantages of the present disclosure are explained below on the basis of the figures, in which:

FIG. 1 shows a schematic representation of a first embodiment of the reagent vessel insert;

FIG. 2 shows a schematic representation of a second embodiment of the reagent vessel insert;

FIGS. 3a and 3b show schematic representations of a third embodiment of the reagent vessel insert;

FIGS. 4a and 4b show schematic representations of a fourth embodiment of the reagent vessel insert;

FIGS. 5a to 5d show schematic representations of a fifth embodiment of the reagent vessel insert;

FIGS. 6a to 6d show schematic representations of a sixth embodiment of the reagent vessel insert;

FIG. 7 shows a schematic representation of a seventh embodiment of the reagent vessel insert;

FIG. 8 shows a schematic representation of an eighth embodiment of the reagent vessel insert;

FIG. 9 shows a schematic representation of a ninth embodiment of the reagent vessel insert;

FIG. 10 shows a schematic representation of a tenth embodiment of the reagent vessel insert;

FIG. 11 shows a schematic representation of an eleventh embodiment of the reagent vessel insert;

FIG. 12 shows a schematic representation of a twelfth embodiment of the reagent vessel insert;

FIG. 13 shows a schematic representation of a centrifuge for explaining an embodiment of the method for the centrifuging of a material; and

FIG. 14 shows a flow diagram for explaining an embodiment of the method for the pressure treatment of a material.

### DETAILED DESCRIPTION

The figures explained below respectively show a reagent vessel insert, or a lower unit of a reagent vessel insert (only partially reproduced). Each of the reagent vessel inserts has an insert housing 10 (not specified any more precisely), which is formed such that the reagent vessel insert can be inserted into a reagent vessel for a centrifuge and/or a pressure varying device. The insertability of a reagent vessel insert into the reagent vessel concerned for a centrifuge and/or a pressure varying device can be interpreted as meaning that an outer wall of the insert housing 10 corresponds to an inner wall of the reagent vessel. Preferably, the outer wall of the insert housing 10 contacts the inner wall of the reagent vessel in such a way that reliable retention of the reagent vessel insert in the reagent vessel concerned is ensured even during operation of the centrifuge and/or the pressure varying device.

The reagent vessel may be understood as meaning for example a (standard) test tube. Other exemplary embodiments are centrifuge tubes, 1.5 ml Eppendorf tubes, 2 ml Eppendorf tubes, 5 ml Eppendorf tubes and microtiter plates, such as for example 20 μl microtiter plates (per cavity) Similarly, the reagent vessel may be a test carrier or a disposable cartridge, which is formed as a lab-on-a-chip system on a plastic substrate the size of a credit card. However, it is pointed out that the way in which the reagent vessel can be formed is not limited to the examples enumerated here. Furthermore, the dimensions of the reagent vessel are only governed by a desired usability of the reagent vessel in the centrifuge and/or in the pressure varying device. However, the way in which the technologies according to the disclosure described hereinafter can be embodied does not prescribe any external form of the reagent vessel. Furthermore, the reagent vessel may be designed for receiving samples in an amount that can be chosen optionally from the range of a few μl to 1 l.

The following explanations also apply to a reagent vessel for a centrifuge and/or a pressure varying device that is formed in a way corresponding to the reagent vessel inserts explained. The advantageous reagent vessel has an outer wall which is formed such that the reagent vessel can be used in a centrifuge and/or in a pressure varying device. In particular, the reagent vessel is formed such that reliable retention of the reagent vessel in the centrifuge that is being operated and/or in the pressure varying device that is being operated is ensured. A reagent vessel for a centrifuge and/or a pressure varying device can consequently be understood as meaning a reagent vessel which, on account of its (external) form, is well suited for operation of the centrifuge with a comparatively great rotational speed and/or for applying by means of the pressure varying device a positive and/or negative pressure deviating greatly from atmospheric pressure. The advantageous reagent vessel may be formed as the embodiments already enumerated above, without being limited to them.

It is pointed out that the centrifuge and pressure varying device mentioned hereinafter should not be understood as meaning any specific types of device. Instead, the technology according to the disclosure can be used by means of any centrifuge by means of which a (minimum) centrifugal force of from 20 g can be exerted. Similarly, the technology according to the disclosure can be used for any pressure varying device by means of which a negative and/or positive pressure can be applied.

The embodiments described below of the reagent vessel insert/reagent vessel have at least one magnet 12, which is arranged non-adjustably with respect to the insert housing 10/the outer wall. The at least one magnet 12 of a reagent vessel may be arranged/secured in the reagent vessel insert and/or on an outer wall of the insert housing 10. In the case of the reagent vessel with the advantageous form, the at least one magnet 12 may also be arranged/secured on and/or in the reagent vessel wall. In a preferred way, the at least one magnet 12 is arranged such that its position in or on the reagent vessel insert/reagent vessel is not changed even when there is a comparatively great centrifugal force/compressive force.

Furthermore, each of the embodiments described below of the reagent vessel insert/reagent vessel also has at least one adjusting element 16 arranged in an interior volume 14 of the reagent vessel insert/reagent vessel. The adjusting element 16 is at least partially formed from a magnetically attractable material, such that a magnetic force of attraction exerted by the at least one magnet 12 on the at least one adjusting element 16 is at least greater than a force of the weight of the at least one adjusting element 16. For example, the at least one adjusting element 16 may comprise as the magnetically attractable material at least one ferromagnetic material and/or a paramagnetic material. In particular, the at least one adjusting element 16 may be at least partially formed from a metal. Furthermore, the at least one adjusting element 16 may also comprise a polymer and/or an elastomer, with which the at least one adjusting element 16 is at least partially coated. Similarly, the at least one adjusting element 16 may comprise multiple magnetic particles, which are integrated in a polymer structure or in an elastomer. The geometry of the at least one adjusting element 16 is freely selectable, it being possible for a diameter of the at least one adjusting value element 16 to lie for example in a range from 1 μm to 3 cm. The at least one adjusting element 16 may be formed for example as a ball, a ring, a plate, a grid, a screen and/or a rod. Further forms may likewise be used for forming the at least one adjusting element 16. The at least one adjusting element 16 may also consist of multiple individual components, such as for example a bead bed. Furthermore, a surface of the at least one adjusting element 16 may be modified such that defined bonding reactions and/or interactions can take place at the surface of the at least one adjusting element 16. For example, the surface of the at least one adjusting element 16 may be modified with strands of DNA, antigens and/or proteins, in particular with antibodies.

In an advantageous way, the at least one adjusting element 16 is adjustable with respect to the at least one magnet 12 by means of a centrifugal force that is brought about when operating the centrifuge in the rotor device of which the reagent vessel with the reagent vessel insert inserted therein is arranged and is greater than the magnetic force of attraction and/or by means of a compressive force that is brought about when operating the pressure varying device in which the reagent vessel with the reagent vessel insert inserted therein is arranged and is greater than the magnetic force of attraction. As specified more precisely below, a magnetic system formed by the at least one magnet 12 and the at least one adjusting element 16 can consequently perform the functions of a cutting-open mechanism, a severing mechanism, a throttle, a valve, a closing device, a flap mechanism, a pump and/or a mixing device. It is pointed out that the magnetic system represents a way of implementing the functions enumerated here in a low-cost way that requires little installation space.

The advantageous way in which the magnetic system realized by the at least one magnet 12 and the at least one adjusting element 16 functions in a centrifuge can consequently be broadly described as that, when there is a rotational acceleration/rotating speed of the centrifuge below a prescribed limit value, the magnetic force exerted on the at least one adjusting element 16 is less than the centrifugal force brought about, and consequently the at least one adjusting element 16 is held in at least one starting position/rest position. The prescribed limit value generally corresponds to a rotational acceleration/rotating speed that is equal to a centrifugal force of the magnetic force exerted by the at least one magnet 12 on the at least one adjusting element 16. If the rotational acceleration/rotating speed of the centrifuge exceeds the prescribed limit value, the centrifugal force brought about on the at least one adjusting element 16 becomes greater than the magnetic force of attraction/retaining force of the magnet 12 exerted on it, and the at least one adjusting element 16, which can no longer be held in its at least one starting position/rest position, is accelerated radially in the direction of the centrifugal force. Consequently, when there is a rotational acceleration/rotating speed of the centrifuge above the prescribed limit value, the at least one adjusting element 16 moves away from the at least one magnet 12 with a movement component directed in the direction of the centrifugal force that is unequal to zero.

The limit value/threshold value for the rotational acceleration/rotating speed of the centrifuge from which the centrifugal force brought about becomes greater than the magnetic force of attraction of the magnet 12 may be at least 20 g, for example at least 100 g, preferably at least 500 g, in particular at least 1000 g. It is pointed out that the threshold value of the rotational acceleration from which the centrifugal force becomes greater than the magnetic force of attraction of the magnet 12 can be fixed in an easy way (freely) in a range between 20 g and 10 000 g. This is possible for example by choosing the parameters of the magnet 12 and/or the material composition of the at least one adjusting element 16.

Correspondingly, the advantageous way in which the magnetic system realized by the at least one magnet 12 and the at least one adjusting element 16 functions in a pressure varying device can be broadly described as that only a negative and/or positive pressure that deviates from atmospheric pressure by at least a prescribed pressure difference brings about a compressive force on the at least one adjusting element 16 that is greater than the magnetic force of attraction of the at least one magnet, and consequently initiates an acceleration of the at least one adjusting element 16 in the direction of the compressive force. The at least one adjusting element 16 also in this case moves away from the at least one magnet 12 with a movement component directed in the direction of the compressive force that is unequal to zero.

The at least one adjusting element 16 is arranged in an interior volume of the reagent vessel insert/reagent vessel in which at least one channel, at least one cavity and/or at least one reaction chamber may be formed. Process steps and structures, such as for example sedimentation structures, channel structures or siphon structures, for passing on and switching at least one liquid contained in the reagent vessel insert/reagent vessel may be integrated in the interior volume of the reagent vessel insert/reagent vessel. In particular, at least one lower unit of the interior volume of the reagent vessel insert/reagent vessel may, as a “reservoir”, be filled with at least one liquid that performs at least one chemical reaction and/or a biochemical/molecular biological process with a material/sample material that is to be processed and/or investigated and is introduced subsequently. The at least one “reservoir” may be filled for example with chemicals, dyes, antibodies, antigens, receptors, proteins, strands of DNA and/or strands of RNA. The interior volume of the reagent vessel insert/reagent vessel may be at least partially made of a polymer, for example of COP, COC, PC, PA, PU, PP, PET and/or PMMA. Other materials are also suitable for forming the interior volume of the reagent vessel insert/reagent vessel. Furthermore, a reagent vessel insert/reagent vessel may also comprise at least one turret and/or a ballpoint pen mechanism. A turret that can be used in the reagent vessel insert/reagent vessel may hold a volume of less than 5 milliliters. A single turret may be designed such that it can be integrated in a stack of further turrets and/or reaction chambers. By means of a ballpoint pen mechanism, the turrets (stacked axially one on top of the other), reaction chambers and/or cavities can be positioned in relation to one another axially and also azimuthally. With respect to one possible embodiment of a turret that can be used and/or the ballpoint pen mechanism, reference is made to DE 2010 003 223 A1. The embodiments described hereinafter of a reagent vessel insert/reagent vessel may also be equipped with additional components, such as for example valves and/or pumps. Furthermore, the technology according to the disclosure may be combined in an easy way with conventional methods such that a magnetic system of the reagent vessel insert/reagent vessel can also interact with a large number of conventional actuation, detection and/or control units.

Chemical and biochemical processes can be executed in a fully automated manner by means of the reagent vessel inserts/reagent vessels described hereinafter. It is pointed out that the figures described can be interpreted as simple applications of the reagent vessel insert/reagent vessels that can be realized.

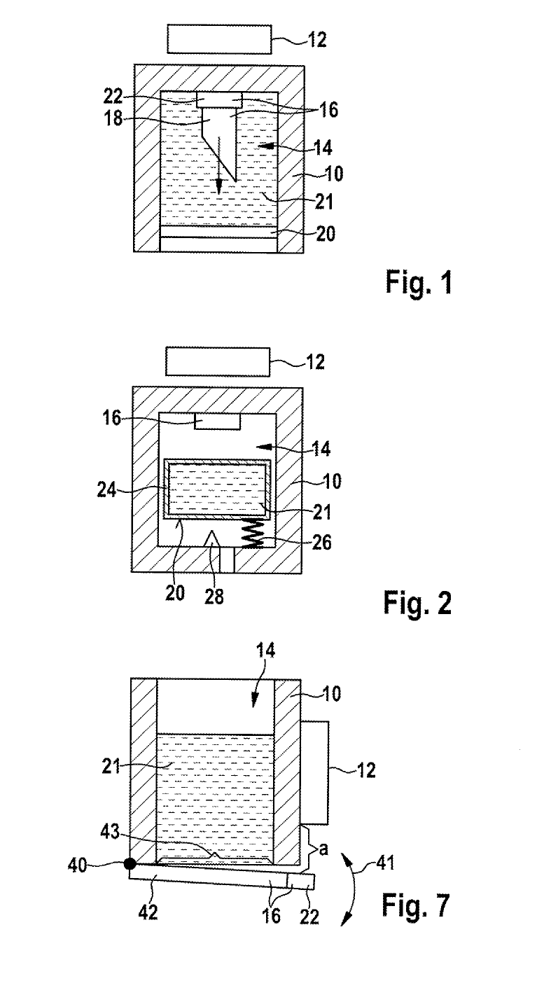

FIG. 1 shows a schematic representation of a first embodiment of a reagent vessel insert.

The reagent vessel insert that is schematically represented (at least partially) in FIG. 1 has an insert housing 10, which is formed such that the reagent vessel insert can be inserted in a reagent vessel for a centrifuge and/or for a pressure varying device. Furthermore, the reagent vessel insert has a magnet 12 (at least one), which is arranged/secured non-adjustably with respect to the insert housing 10. The reagent vessel insert also has at least one adjusting element 16 arranged in an interior volume 14 of the reagent vessel insert.

The at least one adjusting element 16 is adjustable with respect to the at least one magnet 12 by means of the centrifugal force that can be brought about when operating the centrifuge in the rotor device of which the reagent vessel with the reagent vessel insert inserted therein is arranged (and is greater than the magnetic force of attraction) and/or by means of the compressive force that can be brought about when operating the pressure varying device in which the reagent vessel with the reagent vessel insert inserted therein is arranged (and is greater than the magnetic force of attraction). In the case of the embodiment represented, by means of the at least one adjusting element 16 adjusted with respect to the at least one magnet 12, a cutting edge 18, a point and/or a spike can be brought into contact with a layer 20 that can be penetrated by means of the cutting edge 18, the point and/or the spike. In the case of the embodiment of FIG. 1, the adjusting element 16 itself, or a lower unit thereof, is formed as a cutting edge 18 (blade). In addition, the adjusting element 16 also has a lower unit 22, which is formed from a magnetically attractable material. It is consequently not necessary to use a magnetically attractable material for the forming of the cutting edge 18, the point and/or the spike.

If the adjusting element 16 is accelerated as a result of a force greater than the magnetic force of attraction of the at least one magnet 12, it may take up kinetic energy that is sufficient to punch through/sever the penetrable layer 20, which is formed for example as a film, seal or membrane. In this way it is possible for example to release a liquid 21 retained by means of the penetrable layer 20. This can also be broadly described as that a fluidic path can be opened by means of severing the layer 20. The releasable liquid 21 may be stored in a vessel structure in which the at least one adjusting element 16 is also arranged. Similarly, the at least one adjusting element 16, arranged externally from the vessel structure filled with the liquid 21, may be moved toward the penetrable layer 20 by the centrifugal force/compressive force.

The embodiment of FIG. 1 consequently realizes a magnetic system formed by the at least one magnet 12 and the at least one adjusting element 16 that can be referred to as an opening mechanism/cutting-open mechanism for the selective opening/cutting open of a vessel structure and/or as a severing mechanism for the severing of a layer 20. Consequently, a point in time for the selective release of at least one liquid 21 can be fixed by choosing the rotational speed, the negative pressure and/or the positive pressure. The liquid 21 released/flowing out in this way may subsequently perform at least one reaction with a material/sample material.

FIG. 2 shows a schematic representation of a second embodiment of the reagent vessel insert.

The reagent vessel insert that is schematically represented (at least partially) in FIG. 2 is a further realization of a magnetic system formed by the at least one magnet 12 and the at least one adjusting element 16, which can be used as an opening mechanism, a cutting-open mechanism and/or a severing mechanism. In the case of the embodiment of FIG. 2, while executing the movement directed away from the at least one magnet 12, the adjusting element 16 accelerated by means of a force greater than the magnetic force of attraction of the magnet 12 makes contact with a vessel component 24, which is kept at a distance from a spike 28, a cutting edge and/or a point by means of an elastic component 26 and is filled with a liquid 21. The at least one adjusting element 16 accelerated by means of the centrifugal force/compressive force subsequently moves the vessel component 24 toward the spike 28, the cutting edge and/or the point. The layer 20 of the vessel component 24 is in this way pressed against the spike 28, the cutting edge and/or the point, so that a clearance/liquid outlet is formed in the layer 20. Consequently, a specific release of the liquid 21 introduced into the vessel component 24 at a point in time that can be freely chosen/set is also possible by means of the embodiment of FIG. 2.

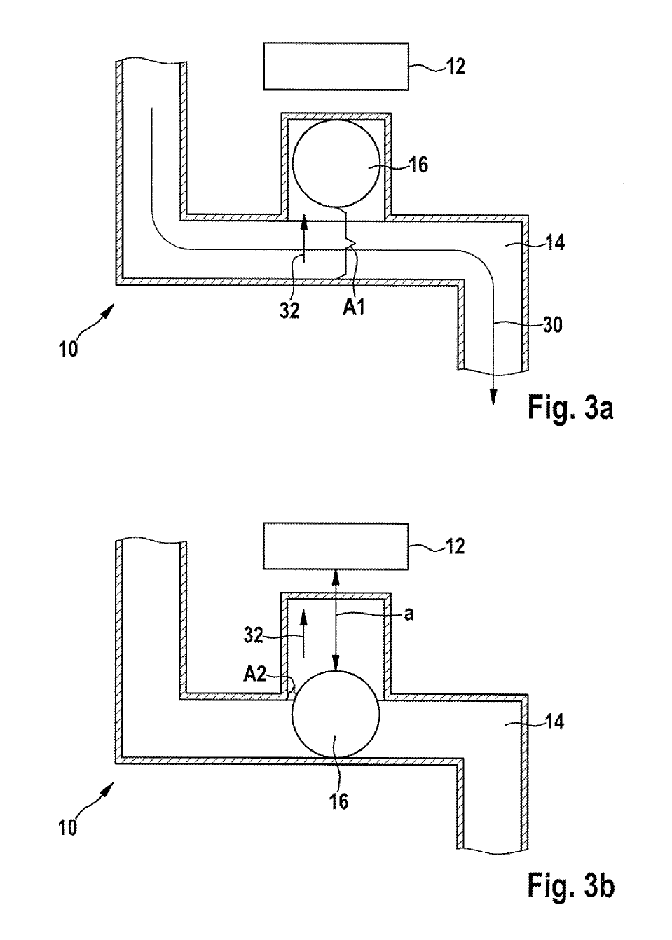

FIGS. 3a and 3b shows schematic representations of a third embodiment of the reagent vessel insert.

In the case of the reagent vessel insert that is schematically reproduced (at least partially) in FIGS. 3a and 3b, the at least one adjusting element 16 is adjustable with respect to the at least one magnet 12 from at least one starting position into at least one operating position by means of the centrifugal force/compressive force.

FIG. 3a shows the at least one adjusting element 16 in its starting position. Between the at least one adjusting element 16 in its starting position and a surrounding of the adjusting element 16 in its starting position there is a first (overall) through-flow area A1. In FIG. 3b, the at least one adjusting element 16 is reproduced in its operating position. Between the at least one adjusting element 16 in its operating position and a surrounding of the at least one adjusting element 16 in its operating position there is a second (overall) through-flow area A2, which is unequal to the first through-flow area A1. (The first (overall) through-flow area A1 and the second (overall) through-flow area A2 may also be understood as meaning the overall through-flow areas comprising multiple through-flow areas of various gaps between each adjusting element 16 and its surrounding in its respective position.)

The magnetic system formed by the at least one magnet 12 and the at least one adjusting element 16 consequently realizes a throttle by means of which a liquid flow 30 that can be made to pass through the interior volume 14 can be controlled. If the first (overall) through-flow area A1 is larger than the second (overall) through-flow area A2, a throttling of the liquid flow 30 that can be made to pass through the interior volume 14 is brought about by a centrifugal force/compressive force greater than the magnetic force of attraction of the at least one magnet 12. Consequently, the flow density of the liquid flow 30 passed through the interior volume 14 can be selectively controlled by means of the centrifugal force/compressive force.

The advantageous magnetic system represented in FIGS. 3a and 3b, which can be used as a throttle, can be realized in an easy way, in that the interior volume 14 is at least partially formed as a channel which has in the effective region of the magnetic force of attraction of the at least one magnet 12 at least one protuberance 32, into which the at least one adjusting element 16 at least partially fits. The magnetic force of attraction of the at least one magnet 12 consequently brings about an adjustment of the at least one adjusting element 16 out of the channel, whereby the advantageously large first (overall) through-flow area A1 is cleared for the liquid flow 30. By means of a centrifugal force/compressive force greater than the magnetic force of attraction of the magnet 12, the at least one adjusting element 16 can be adjusted out of the at least protuberance 32 into the channel, whereby the liquid flow 30 is throttled in an easy way.

It is pointed out that the realizable throttle/throttling can be designed reversibly, depending on a distance a (average distance) between the at least one magnet 12 and the at least one adjusting element 16 in its at least one operating position. If the magnetic force of attraction of the at least one magnet 12 is sufficient still to draw the at least one adjusting element 16 arranged at the distance a from it from its at least one operating position back into the at least one starting position, the at least one adjusting element 16 can be moved back again into its (original) at least one starting position when there is a decrease/reduction in the centrifugal force/compressive force exerted on it. If so desired, in this case the at least one adjusting element 16 may at a later point in time be adjusted into its operating position by means of a sufficiently great centrifugal force/compressive force once again for throttling the liquid flow 30.

To realize a reversible magnetic system, the return of the at least one adjusting element 16 into the starting position/rest position may also be assisted by an elastic element (not depicted). An elastomer and/or a spring mechanism may be used for example as the elastic element. The elastic element and the at least one adjusting element 16 may be designed as two separate components. It is similarly possible to form the at least one adjusting element 16 as a one-piece/one-part component with an elastic element. For example, the at least one adjusting element 16 may be a magnetic particle that is at least partially coated with an elastic material (elastomer/polymer). As an addition or alternative to this, a magnetic particle that can be used as the at least one adjusting element 16 may be connected to a spring or be integrated in a spring.

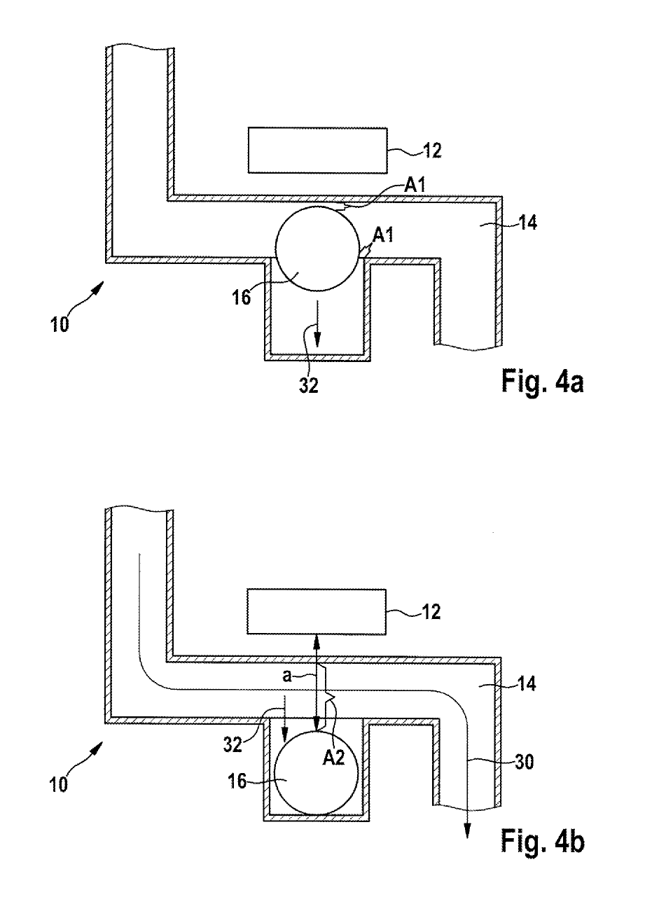

FIGS. 4a and 4b shows schematic representations of a fourth embodiment of the reagent vessel insert.

In the case of the reagent vessel insert that is schematically represented (at least partially) in FIGS. 4a and 4b, the first (overall) through-flow area A1 between the at least one adjusting element 16 and a surrounding of the at least one adjusting element 16 in its starting position is smaller than the second (overall) through-flow area A2 between the at least one adjusting element 16 in its operating position and a surrounding of the at least one adjusting element 16 in its operating position. The magnetic system of FIGS. 4a and 4b consequently realizes a throttle by means of which a liquid flow 30 can be increased by adjusting the at least one adjusting element 16 into its at least one operating position and can be reduced/throttled by adjusting the at least one adjusting element 16 into its at least one starting position. (The direction of flow of the liquid flow 30 may be different from the direction of movement of the adjusting element 16 moved by means of the centrifugal force/compressive force.)

For example, by means of the magnetic force of attraction, the at least one adjusting element 16 is held in its at least one starting position (centrally) in a channel in which at least one protuberance 32 is formed near the at least one adjusting element 16. When there is a centrifugal force/compressive force exceeding the magnetic force of attraction, the at least one adjusting element 16 is captured/held in the at least one protuberance 32 as its at least one operating position.

By means of fixing a distance a (average distance) from the at least one adjusting element 16 in its at least one operating position to the at least one magnet 12 and the parameters of the at least one magnet 12, the embodiment reproduced in FIGS. 4a and 4b as a reversible throttle can also be formed. This advantage can also be brought about by the return of the at least one adjusting element 16 into the starting position/rest position being assisted by means of an elastic element (not depicted).

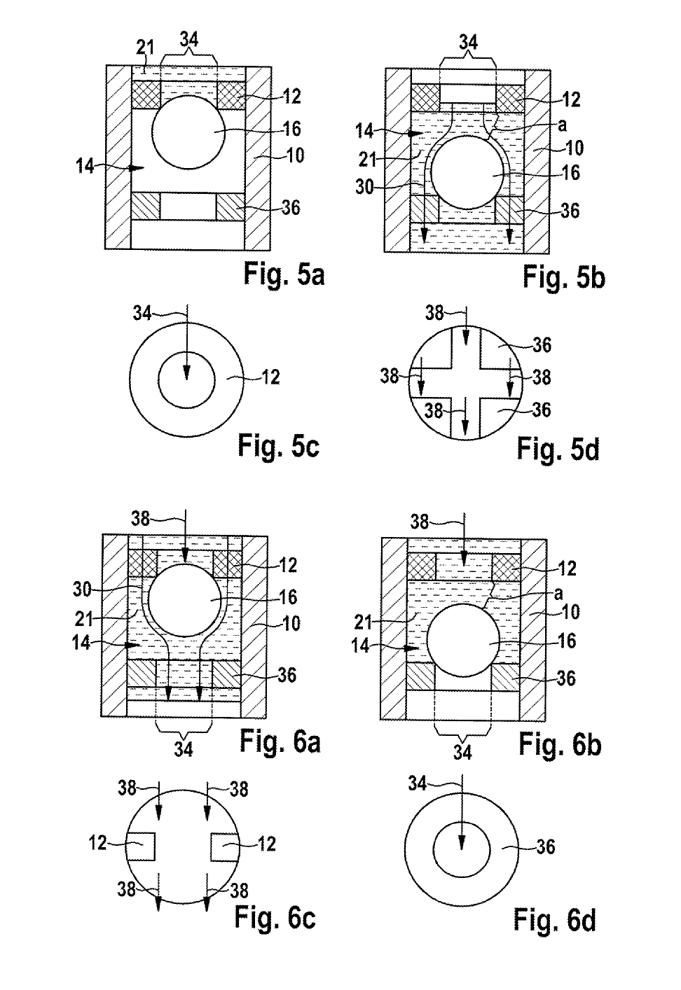

FIGS. 5a to 5d shows schematic representations of a fifth embodiment of the reagent vessel insert.

The reagent vessel insert that is schematically reproduced (at least partially) in FIGS. 5a to 5d has a magnetic system formed by at least the at least one magnet 12 and the at least one adjusting element 16, which is realized as a valve. If the at least one adjusting element 16 does not experience a centrifugal force/compressive force greater than the magnetic force of attraction of the magnet 12, the valve realized is closed. This is ensured since, in its at least one starting position, the at least one adjusting element 16 closes with a liquidtight seal a channel-restricting region 34 that is formed in the interior volume 14 (see FIG. 5a). The exertion of a centrifugal force/compressive force greater than the magnetic force of attraction of the at least one magnet 12 on the at least one adjusting element 16 allows the valve to be opened.

In the case of the embodiment of FIGS. 5a to 5d, the interior volume 14 is at least partially formed as a fluidic channel with a channel-restricting region 34, which the at least one adjusting element 16 completely covers/blocks in its at least one starting position/rest position. In the case of the embodiment represented, an annular magnet 12 restricting the cross-sectional area of the channel is integrated in the channel to form the channel-restricting region 34. (The annular magnet 12 is depicted in FIG. 5c). A ball, which at least partially consists of a magnetically attractable material, may be used as the at least one adjusting element 16.

By means of a centrifugal force/compressive force greater than the magnetic force of attraction of the magnet 12, the at least one adjusting element 16 is moved in the direction of the force vector toward a catching structure 36, by means of which an operating position of the at least one adjusting element 16, or a distance a (average distance) between the at least one adjusting element 16 in its operating position and the at least one magnet 12, can be fixed (see FIG. 5b). As can be seen in FIG. 5d, the catching structure 36 has at least one bypass 38, which is not covered by the at least one adjusting element 16 in its operating position. Consequently, liquid 21 can flow around the at least one adjusting element 16 in its operating position and can flow through the catching structure 36 through the at least one bypass 38.

Fixing the distance a and/or the parameters of the magnet 12 allows the valve that is reproduced by FIGS. 5a to 5d to be designed reversibly. If, on the basis of the distance a and the parameters of the magnet 12, the magnetic force of attraction is sufficient, the at least one adjusting element 16 may be adjusted back again from an operating position into its starting position by means of the magnet 12 when there is a decrease in the centrifugal force/compressive force and close the fluidic channel once again. A renewed increase in the centrifugal force/compressive force allows the at least one adjusting element 16 to be moved into its operating position again, whereby the valve can be controlled into an open state once again. It is pointed out that the operation described in this paragraph can be repeated as often as desired and/or periodically.

FIGS. 6a to 6d shows schematic representations of a sixth embodiment of the reagent vessel insert.

The reagent vessel insert that is reproduced (at least partially) in FIGS. 6a to 6d comprises a magnetic system which is formed by the at least one magnet 12 and the at least one adjusting element 16 and in which the adjusting element 16 in its operating position closes the channel-restricting region 34 that is formed in the interior volume 14 (see FIG. 6b). The embodiment of FIGS. 6a to 6d consequently realizes a valve which, in the absence of a centrifugal force/compressive force canceling out the magnetic force of attraction of the magnet 12, is in an open state.

For example, the at least one magnet 12, which is represented in FIG. 6c in a plan view, is formed such that, even when the at least one adjusting element 16 is in its starting position, there is still a clear bypass 38, through which the liquid flow 30 can flow. This allows the liquid flow 30 to flow around the at least one adjusting element 16 in its starting position/rest position, to flow through the clear bypass 38 and to be passed through the interior volume 14 that is at least partially formed as a channel (see FIG. 6a). The channel can be closed by the at least one adjusting element 16 being adjusted by means of a centrifugal force/compressive force that exceeds the magnetic force of attraction of the magnet 12 and has a movement component directed along the force vector into at least one operating position, in which the at least one adjusting element 16 (completely) covers/blocks a channel-restricting region 34. To form a suitable channel-restricting region 34, an annular catching structure 36, as represented in FIG. 6d, may be secured in the channel. A channel-restricting region 34 framed by the annular catching structure 36 can in this case be reliably blocked/covered by means of at least one adjusting element 16 formed as a ball, such that the liquid flow 30 is stopped.

The embodiment reproduced in FIGS. 6a to 6d can also be designed reversibly by means of suitably fixing a distance a between the magnet 12 and the at least one adjusting element 16 in its operating position, the parameters of the magnet 12 and/or an elastic element.

FIG. 7 shows a schematic representation of a seventh embodiment of the reagent vessel insert.

The reagent vessel insert that is schematically represented (at least partially) in FIG. 7 has as the at least one adjusting element 16 a closing device that can be pivoted about a hinge 40. For example, the adjusting element 16 may be secured by means of the hinge 40 at an opening 43 of a vessel structure. The adjusting element may comprise a lower unit 22 of a magnetically attractable material, which is arranged alongside the at least one magnet 12 at the end of the adjusting element 16 that is directed away from the hinge 40. Furthermore, the adjusting element 16 may also have a sealing plate 42 for the (liquidtight and/or gastight) covering of the opening 43, for the forming of which a non-magnetically attractable material may also be used.

If no centrifugal force/compressive force cancels out the force of attraction of the at least one magnet 12, the adjusting element 16 remains in its starting position and covers the opening 43 of the vessel structure with its sealing plate 42. Only as from when there is a centrifugal force/compressive force canceling out the magnetic force of attraction is the adjusting element 16 moved along an arcuate path 41 and pivoted about the hinge 40, whereby the opening 43 of the vessel structure is “swung open”. The magnetic system formed by the at least one magnet 12 and the at least one adjusting element 16 consequently realizes the closing device, or a flap mechanism.

Suitable fixing of the distance a of the adjusting element 16 in its operating position from the at least one magnet 12, of the parameters of the at least one magnet 12 and/or an elastic element allows the closing device/flap mechanism also to be designed reversibly. In this case, a decrease/reduction in the centrifugal force/compressive force can bring about a re-closing of the opening 43 that can be sealed by means of the adjusting element 16.

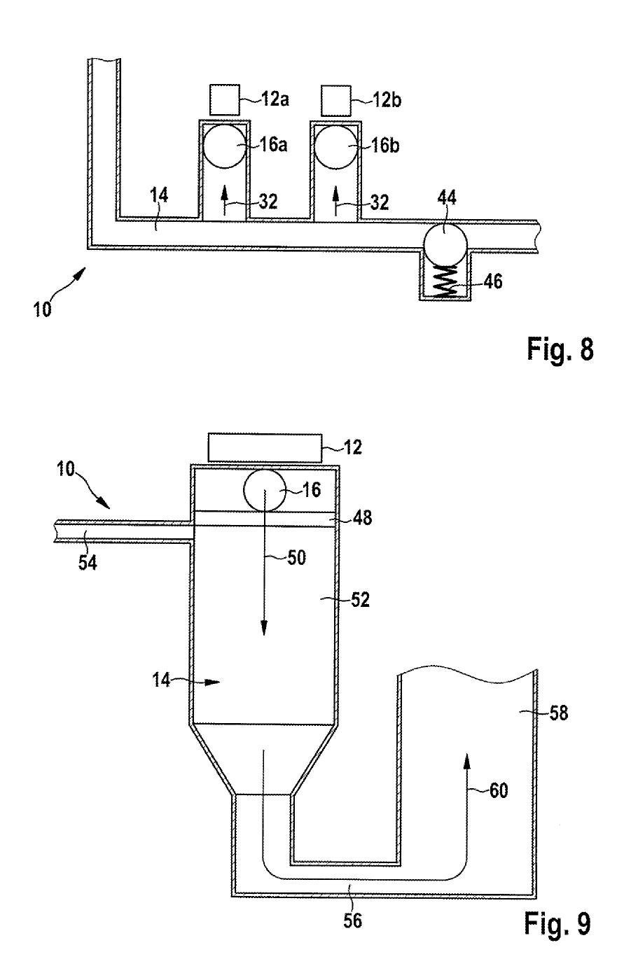

FIG. 8 shows a schematic representation of an eighth embodiment of the reagent vessel insert.

The reagent vessel insert that is schematically represented (at least partially) in FIG. 8 comprises a first adjusting element 16a and a second adjusting element 16b. The first adjusting element 16a and the second adjusting element 16b are in their starting positions, in each case in a protuberance 32 of the interior volume 14 that is at least partially formed as a channel. The first adjusting element 16a and the second adjusting element 16b are respectively assigned a first magnet 12a and a second magnet 12b. In the case of the embodiment of FIG. 8, the centrifuge also has a sealing element 44, an elastic component 46 being arranged between the sealing element 44 and a wall of a further protuberance 32 assigned to the sealing element 44. If no further force acts on the sealing element 44, the sealing element 44 is pressed at least partially out of the protuberance 32 assigned to it by means of the elastic component 46.

By means of a first centrifugal force/compressive force greater than a first magnetic force of attraction of the first magnet 12a on the first adjusting element 16a, the first adjusting element 16a can be adjusted out of its protuberance 32 into the channel, whereby a partial region of the channel on which the protuberance 32 of the second adjusting element 16b lies is sealed at its first end by means of the first adjusting element 16a and at its second end by means of the sealing element 44. If the centrifugal force is increased further, so that a second magnetic force of attraction of the second magnet 12b on the second adjusting element 16b is also exceeded, the adjustment of the second adjusting element 16b into the channel-restricting region sealed at both its ends brings about a positive pressure, whereby the sealing element 44 is pressed into the protuberance 32 assigned to it against a counterforce of the elastic component 46 and liquid 21 is pumped out from the channel-restricting region. It is pointed out that the positive pressure that can be generated may be sufficient for pumping the liquid 21 counter to the centrifugal force/compressive force. When there is a decrease/reduction in the centrifugal force/compressive force, the two adjusting elements 16a and 16b and the sealing element 44 return again into their starting positions. Consequently, the pumping operation described in this paragraph can be repeated as often as desired. The embodiment of FIG. 8 consequently realizes a pumping device/pump.

FIG. 9 shows a schematic representation of a ninth embodiment of the reagent vessel insert.

The reagent vessel insert that is schematically represented (at least partially) in FIG. 9 represents another example of a pumping device/pump that can be realized by means of the at least one magnet 12 and the at least one adjusting element 16. In the case of the embodiment represented, the at least one adjusting element 16 makes contact with a sealing element 48, which is adjustably arranged in a pumping chamber 52 with an inlet 54 and an outlet 56. While the at least one adjusting element 16 is in its starting position, the sealing element 48 is kept away from the inlet 54, such that filling of the pumping chamber 52 with a liquid 21 or a gas is possible via the inlet 54. When there is a centrifugal force/compressive force exceeding the magnetic force of attraction of the magnet 12, the at least one adjusting element 16 moves the sealing element 58 along a direction 50 toward the outlet 56, the sealing element 48 that covers the cross section of the pumping chamber 52 (with a liquidtight and/or gastight seal) forcing the material that has been introduced into it through the outlet 56 as a liquid or gas flow 60.

A decrease/reduction in the centrifugal force/compressive force may bring about a return adjustment of the at least one adjusting element 16 and the sealing element 58. The pumping operation described in the previous paragraph can consequently be repeated as often as desired. By means of repeating the pumping operation a number of times, in particular periodically, a considerable amount of liquid or amount of gas can be pumped through the outlet 56 into a volume 58 connected thereto. It is pointed out that the pumping device described here can also be used for pumping a liquid 21 or a gas into the connected volume 58 counter to the centrifugal force/compressive force.

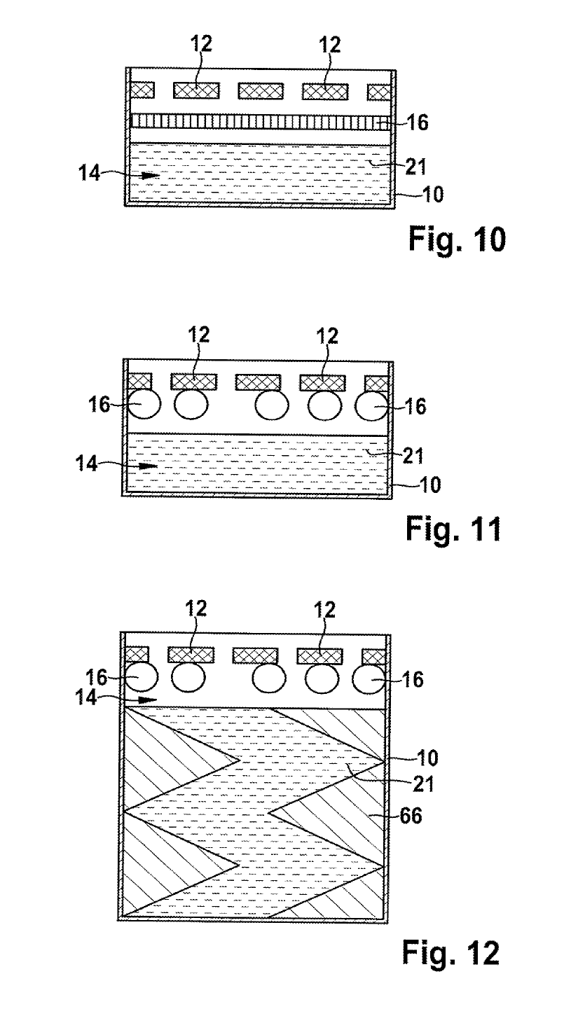

FIG. 10 shows a schematic representation of a tenth embodiment of the reagent vessel insert.

The reagent vessel insert that is schematically represented (at least partially) in FIG. 10, with at least one adjusting element 16 formed as a screen, realizes a mixing device for mixing a liquid 21 that is in the interior volume 14. For this purpose, the at least one adjusting element 14 is preferably moved reversibly back and forth between its starting position and at least one operating position. In this way, it is even possible to mix at least two liquids efficiently with one another.

FIG. 11 shows a schematic representation of an eleventh embodiment of the reagent vessel insert.

The embodiment of FIG. 11 has multiple adjusting elements 16, which are formed for example as balls or beads. If the magnetic force of attraction of the at least one magnet 12 is not canceled out by a centrifugal force or compressive force, the adjusting elements 16 are in their starting positions. When there is a centrifugal force/compressive force exceeding the magnetic force of attraction, the adjusting elements 16 move and produce a flow profile in the liquid 21. By contrast, a decrease/reduction in the centrifugal force/compressive force brings about a renewed attraction of the adjusting elements 16 into their starting positions by means of the magnetic force of attraction of the magnet 12. A periodic raising and lowering of the centrifugal force/compressive force, varying about a threshold value equal to the magnetic force of attraction, consequently allows an advantageous mixing effect to be brought about.

FIG. 12 shows a schematic representation of a twelfth embodiment of the reagent vessel insert.

The embodiment of FIG. 12 has as an addition to the preceding embodiment additional obstructing structures in the interior volume 14 that is at least partially acting as a mixing chamber. For example, the interior volume 14 may comprise a zigzag channel 66 as a mixing chamber, whereby a Dean effect can be formed.

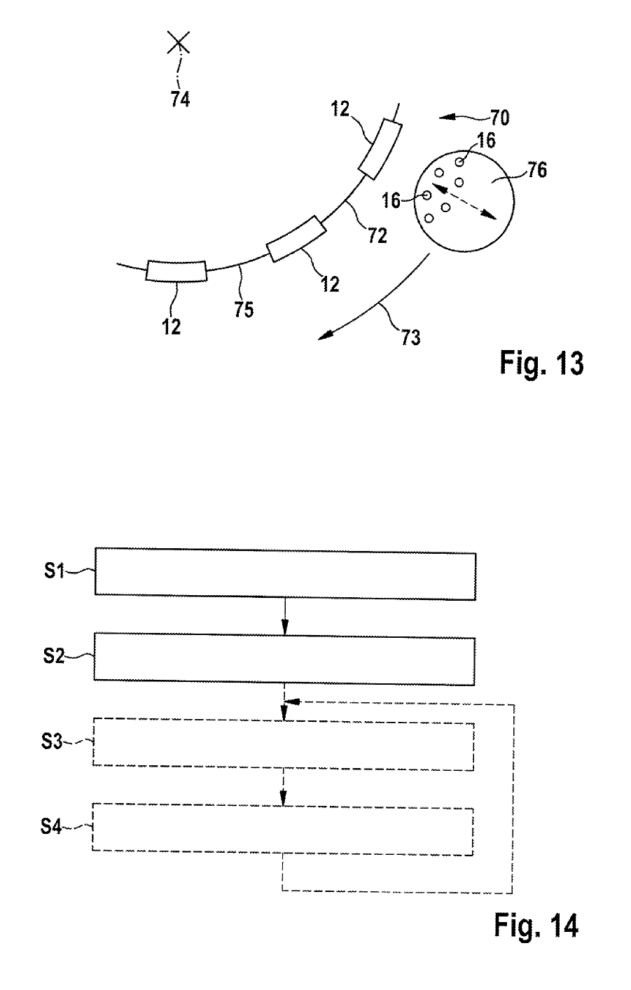

FIG. 13 shows a schematic representation of a centrifuge for explaining an embodiment of the method for the centrifuging of a material.

The centrifuge 70 schematically represented in FIG. 13 has a rotary device 72, which can rotate with a variable rotating speed along circular path 73 about the center of rotation 74. By means of the centrifuge 70, a centrifugal acceleration of up to 10 000 g can be brought about for example. However, the centrifuge 70 that can be used for the method is not restricted to a maximum or minimum centrifugal acceleration that can be brought about.

To execute the method, the material 76 to be centrifuged (for example a sample material) is introduced into a reagent vessel with a reagent vessel insert inserted therein or is introduced into a reagent vessel equipped with the advantageous technology. The reagent vessel insert/reagent vessel interacting with the material 76 has at least one magnet 12 and at least one adjusting element 16. (The at least one magnet 12 may be arranged on a mount 75.) It is pointed out that all of the embodiments described above of the reagent vessel insert/reagent vessel can be used for executing the method. However, the way in which the method can be executed is not limited to one use of the embodiments described above of the reagent vessel insert/reagent vessel. Similarly, the way in which the method can be executed is not restricted to one specific material to be centrifuged.

During the method, the centrifuge 70 is operated for a first time interval at a current rotating speed corresponding to a first setpoint rotating speed, which brings about on the at least one adjusting element a first centrifugal force, which is greater than the magnetic force of attraction exerted on it. In this way, the magnetic system formed by the at least one magnet 12 and the at least one adjusting element 16 can be operated as a cutting-open mechanism, a severing mechanism, a throttle, a valve, a closing device, a flap mechanism, a pump and/or a mixing device.

In an advantageous embodiment of the method, after the first time interval, for a second time interval there takes place at least a one-off interim reduction in the current rotating speed to a second setpoint rotating speed, which brings about on the at least one adjusting element a second centrifugal force, which is less than the magnetic force of attraction exerted on it, and subsequently for a third time interval there takes place an increase in the current rotating speed to a third setpoint rotating speed, which brings about on the at least one adjusting element a third centrifugal force, which is greater than the magnetic force of attraction exerted on it. The third setpoint rotating speed may be equal to the first setpoint rotating speed. This brings about for example an additional mixing of the material 66 to be centrifuged.

FIG. 14 shows a flow diagram for explaining an embodiment of the method for the pressure treatment of a material.

It is pointed out that all of the embodiments described above of the reagent vessel insert/reagent vessel can be used for executing the method. However, the way in which the method is executed is not limited to one use of the embodiments described above of the reagent vessel insert/reagent vessel.

In a method step S1, the material to be treated is introduced into a reagent vessel with a reagent vessel insert inserted therein and/or into a reagent vessel equipped with the advantageous technology. The material to be treated may for example be a sample to be investigated and/or to be processed. It may comprise biomolecules, such as for example strands of DNA, strands of RNA, proteins, in particular antibodies and/or antigens. The way in which the method can be executed is not restricted to one specific material to be treated.

In at least one method step S2, there takes place an application of a negative or positive pressure corresponding to a first setpoint pressure, which for a first time interval brings about on the at least one adjusting element a first compressive force, which is greater than the magnetic force of attraction exerted on it.

In a preferred way, the method also has method steps S3 and S4. In method step S3, there takes place an equalization of the negative or positive pressure for a second time interval in the direction of atmospheric pressure to a second setpoint pressure, which brings about on the at least one adjusting element a second compressive force, which is less than the magnetic force of attraction exerted on it. Method step S4 comprises an intensification of the negative or positive pressure for a third time interval away from atmospheric pressure to a third setpoint pressure, which brings about on the at least one adjusting element a third compressive force, which is greater than the magnetic force of attraction exerted on it. The third setpoint pressure may be equal to the first setpoint pressure. Method steps S3 and S4 may be repeated alternately as often as desired.

What is claimed is:

1. A reagent vessel insert, comprising:
an insert housing formed in such a way that the reagent vessel insert is configured to be inserted in a reagent vessel for one or more of a centrifuge and a pressure varying device;
at least one magnet arranged non-adjustably with respect to the insert housing; and
at least one adjusting element arranged in an interior volume of the reagent vessel insert, the at least one adjusting element being at least partially formed from a magnetically attractable material such that a magnetic force of attraction exerted by the at least one magnet on the at least one adjusting element is at least greater than a force of the weight of the at least one adjusting element.

2. The reagent vessel insert according to claim 1, wherein the at least one adjusting element is adjustable with respect to the at least one magnet by one or more of (i) a centrifugal force brought about when operating the centrifuge in a rotor device of which the reagent vessel with the reagent vessel insert inserted therein is arranged, the centrifugal force being greater than the magnetic force of attraction, and (ii) a compressive force brought about when operating the pressure varying device in which the reagent vessel with the reagent vessel insert inserted therein is arranged, the compressive force being greater than the magnetic force of attraction.

3. The reagent vessel insert according to claim 2, wherein adjusting the at least one adjusting element with respect to the at least one magnet enables one or more of a cutting edge, a point, and a spike to be brought into contact with a layer configured to be penetrated by the one or more of the cutting edge, the point, and the spike.

4. The reagent vessel insert according to claim 2, wherein the at least one adjusting element is adjustable with respect to the at least one magnet from at least one starting position into at least one operating position, the at least one adjusting element and a surrounding of the at least one adjusting element defining (i) a first through-flow area therebetween when the at least one adjusting element is in the at least one starting position and (ii) a second through-flow area therebetween when the at least one adjusting element is in the at least one operating position, the first and second through-flow areas being unequal.

5. The reagent vessel insert according to claim 4, wherein the at least one adjusting element in one or more of the at least one starting position and the at least one operating position closes with a liquid-tight seal a channel-restricting region that is formed in the interior volume.

6. The reagent vessel insert according to claim 1, further comprising one or more of at least one turret and a ballpoint pen mechanism.

7. The reagent vessel insert according to claim 1, wherein the at least one magnetic system formed by the at least one magnet and the at least one adjusting element are configured as one or more of a cutting-open mechanism, a severing mechanism, a throttle, a valve, a closing device, a flap mechanism, a pump, and a mixing device.

8. A reagent vessel comprising:
an outer wall formed in such a way that the reagent vessel is configured to be used in one or more of a centrifuge and a pressure varying device;
at least one magnet arranged non-adjustably with respect to the outer wall; and
at least one adjusting element arranged in an interior volume of the reagent vessel, the at least one adjusting element being at least partially formed from a magnetically attractable material such that a magnetic force of attraction exerted by the at least one magnet on the at least one adjusting element is at least greater than a force of the weight of the at least one adjusting element.

9. The reagent vessel according to claim 8, wherein the at least one adjusting element is adjustable with respect to the at least one magnet by one or more of (i) a centrifugal force brought about when operating the centrifuge in a rotor device of which the reagent vessel is inserted, the centrifugal force being greater than the magnetic force of attraction, and (ii) a compressive force brought about when operating the pressure varying device in which the reagent vessel is inserted, the compressive force being greater than the magnetic force of attraction.

10. The reagent vessel according to claim 9, wherein adjusting the at least one adjusting element with respect to the at least one magnet enables one or more of a cutting edge, a point, and a spike to be brought into contact with a layer configured to be penetrated by the one or more of the cutting edge, the point, and the spike.

11. The reagent vessel according to claim 9, wherein the at least one adjusting element is adjustable with respect to the at least one magnet from at least one starting position into at least one operating position, the at least one adjusting element and a surrounding of the at least one adjusting element defining (i) a first through-flow area therebetween when the at least one adjusting element is in the at least one starting position and (ii) a second through-flow area therebetween when the at least one adjusting element is in the at least one operating position, the first and second through-flow areas being unequal.

12. The reagent vessel according to claim 11, wherein the at least one adjusting element in one or more of the at least one starting position and the at least one operating position closes with a liquid-tight seal a channel-restricting region that is formed in the interior volume.

13. The reagent vessel according to claim 8, further comprising one or more of at least one turret and a ballpoint pen mechanism.

14. The reagent vessel according to claim 8, wherein the at least one magnetic system formed by the at least one magnet and the at least one adjusting element are configured as one or more of a cutting-open mechanism, a severing mechanism, a throttle, a valve, a closing device, a flap mechanism, a pump, and a mixing device.

15. A method for the centrifuging or pressure treatment of a material, comprising:
introducing the material to be centrifuged or pressure treated into a reagent vessel with a reagent vessel insert inserted therein, the reagent vessel insert including:
an insert housing formed in such a way that the reagent vessel insert is configured to be inserted in a reagent vessel for one or more of a centrifuge and a pressure varying device;
at least one magnet arranged non-adjustably with respect to the insert housing; and
at least one adjusting element arranged in an interior volume of the reagent vessel insert, the at least one adjusting element being at least partially formed from a magnetically attractable material such that a magnetic force of attraction exerted by the at least one magnet on the at least one adjusting element is at least greater than a force of the weight of the at least one adjusting element;
if the material is to be centrifuged, operating a centrifuge at a current rotating speed corresponding to a first setpoint rotating speed for a first time interval so as to bring about a first centrigual force on the at least one adjusting element, the first centrifugal force being greater than the magnetic force of attracting exerted on the at least one adjusting element; and
if the material is to be pressure treated, applying a negative or positive pressure corresponding to a first setpoint pressure at least as a one-off measure for a first time interval so as to bring about a first compressive force on the at least one adjusting element, the first compressive force being greater than the magnetic force of attraction exerted on the at least one adjusting element.

16. The method according to claim 15, the centrifuging further comprising:
making at least a one-off interim reduction in the current rotating speed to a second setpoint rotating speed for a second time interval so as to bring about a second centrifugal force on the at least one adjusting element, the second centrifugal force being less than the magnetic force of attraction exterted on the at least one adjusting element; and
making an increase in the current rotating speed to a third setpoint rotating speed for a third time interval so as to bring about a third centrifugal force on the at least one adjusting element, the third centrifugal force being greater than the magnetic force of attraction exterted on the at least one adjusting element.

17. The method according to claim 15, the pressure treatment further comprising:
equalizing the negative or positive pressure in the direction of atmospheric pressure to a second setpoint pressure at least as a one-off measure for a second time interval so as to bring about a second compressive force on the at least one adjusting element, the second compressive force being less than the magnetic force of attraction exerted on the at least one adjusting element; and
intensifying the negative or positive pressure away from atmospheric pressure to a third setpoint pressure for a third time interval so as to bring a third compressive force on the at least one adjusting element, the third compressive force being greater than the magnetic force of attraction exerted on the at least one adjusting element.
